(19) United States
(12) Patent Application Publication
(10) Pub. No.: US 2021/0147006 A1
(43) Pub. Date: May 20, 2021

(54) UNLOADING APPARATUS

(71) Applicant: Wuyi University, Jiangmen (CN)

(72) Inventors: Tianlei WANG, Jiangmen (CN); Wenhui LUO, Jiangmen (CN); Yuanqin LAI, Jiangmen (CN); Jingling ZHANG, Jiangmen (CN); Yijia DENG, Jiangmen (CN); Zhenhua OU, Jiangmen (CN); Junda DENG, Jiangmen (CN); Simin LYU, Jiangmen (CN)

(21) Appl. No.: 16/976,975

(22) PCT Filed: May 22, 2020
(86) PCT No.: PCT/CN2020/091795

§ 371 Date: Aug. 31, 2020

(30) Foreign Application Priority Data
May 23, 2019 (CN) 201920755082.9

(51) Int. Cl. B62D 33/02; B60P 3/00

(52) U.S. Cl. CPC B62D 33/02; B60P 3/00

(57) ABSTRACT

Disclosed is an unloading apparatus, which includes: an insert plate forming a loading space, a bottom plate configured for lifting up and down relative to the insert plate, a lifting device, an unloading plate and a frame plate. The lifting device is connected to the bottom plate, when the lifting device is in an extended state, the lifting device drives the bottom plate to rise as a whole to achieve the lifting function; an angle is formed between the bottom plate and the frame plate.

### CROSS-REFERENCE TO RELATED APPLICATION

This application is a national stage application under 35 U.S.C. 371 of PCT Application No. PCT/CN2020/091795, filed on 22 May 2020, which PCT application claimed the benefit of Chinese Patent Application No. 2019207550829, filed on 23 May 2019, the entire disclosure of each of which are hereby incorporated herein by reference.

### TECHNICAL FIELD

The present disclosure relates to the field of tools, in particular to an unloading apparatus.

### BACKGROUND

In the existing unloading apparatus, a hydraulic push rod is arranged at a bottom of one end of the carriage of the transport vehicle, and a bottom of the other end of the carriage is hinged to the transport vehicle. Through hydraulic transmission, the push rod is extended, and at the same time one end of the box is lifted. When the one end of the carriage is lifted to a certain height, due to the inclination of the carriage relative to horizontal plane, the material will automatically slide down to the lower end of the carriage due to its own gravity to realize the unloading action. However, this type of unloading apparatus is unstable when unloading materials, and the overall lifting force is uneven, the stress at the single fulcrum of the carriage is easy to concentrate thus producing deflection, which is easy to cause strain cracking. Moreover, the carriage body is easy to deform and roll over. Meanwhile, the material will slide down fast causing a large impact force, so that the material will be damaged to varying degrees.

### SUMMARY

In order to address the above problem, the purpose of the present disclosure is to provide an unloading apparatus, which can realize stable lifting of the bottom plate and make it evenly stressed, so that the unloading apparatus is not easy to roll over and crack. When reaching a certain height, the material will automatically slide down at a stable speed, which effectively protects the material and reduces damage.

The technical solutions adopted by the disclosure to address the problems are as follows.

The disclosure proposes an unloading apparatus, which includes: an insert plate forming a loading space, a bottom plate configured for lifting up and down relative to the insert plate, a lifting device, an unloading plate, and a frame plate; the lifting device is fixedly connected with the frame plate and the bottom plate respectively, and the unloading plate is connected with a top of the insert plate; and a first acute angle is formed between the bottom plate and the frame plate.

Further, the lifting device includes: a z-shaped connector, a push rod and a stepping motor; the push rod is fixedly arranged outside the loading space; the Z-shaped connector includes: a first connecting piece, a second connecting piece and a third connecting piece, the first connecting piece is connected to a push rod, and the third connecting piece is connected to the bottom plate, the second connecting piece is arranged in the loading space and fixedly connected to the first connecting piece and the third connecting piece; a plane where the first connecting piece is located and a plane where the third connecting piece is located form a second acute angle that is consistent with the first acute angle; the stepping motor is connected with the push rod.

Further, extension and contraction of the lifting device is controlled by a controller.

Further, the first acute angle is set to 30 degrees.

Further, the insert plate is provided with a depression, and the unloading plate is connected with the insert plate at the depression.

Further, two sides of the unloading plate are provided with a fixing plate for enhancing strength of the unloading plate and guiding the unloading of materials; the fixing plate is fixedly connected with the insert plate at the depression.

The technical solutions provided in the embodiments of the present disclosure have at least the following beneficial effects: the lifting device is connected to the bottom plate, when in an extended state, the lifting device can drive the bottom plate to rise as a whole to achieve the lifting function; a first angle is formed between the bottom plate and the frame plate, so that the materials in the loading space is subject to a downwardly inclined sliding force, when the bottom plate is lifted to the height of the unloading plate, the materials are automatically unloaded by sliding through gravity, the operation process is simple, the sliding speed is stable, which effectively protects the materials and reduce the damage to the materials.

### BRIEF DESCRIPTION OF THE DRAWINGS

The disclosure will be further described below with reference to the drawings and examples.

FIG. 1 is an overall structural diagram of an embodiment of the unloading apparatus of the present disclosure;

FIG. 2 is a structural diagram of a Z-shaped connecting piece of an embodiment of the unloading apparatus of the present disclosure;

FIG. 3 is a side view of an embodiment of the unloading apparatus of the present disclosure.

### DETAILED DESCRIPTION

In the existing unloading apparatus, a hydraulic push rod is arranged at a bottom of one end of the carriage of the transport vehicle, and the other end of the carriage is hinged to the transport vehicle. Through hydraulic transmission, the push rod is extended, and at the same time one end of the box is lifted to realize the unloading action. However, this type of unloading apparatus is unstable when unloading materials, and the overall lifting force is uneven, the stress at the single fulcrum of the car is easy to concentrate thus producing deflection, which is easy to cause strain cracking. Moreover, the carriage body is easy to deform and roll over, at the same time, the material slides down faster causing a large impact force, so that the material will be damaged to varying degrees.

Based on this, the disclosure provides an unloading apparatus, which can realize stable lifting of the bottom plate and make it evenly stressed, so that the unloading apparatus is not easy to roll over and crack. When reaching a certain height, the material will automatically slide down at a stable speed, which effectively protects the material and reduces damage.

The embodiments of the present disclosure will be further described below in conjunction with the drawings.

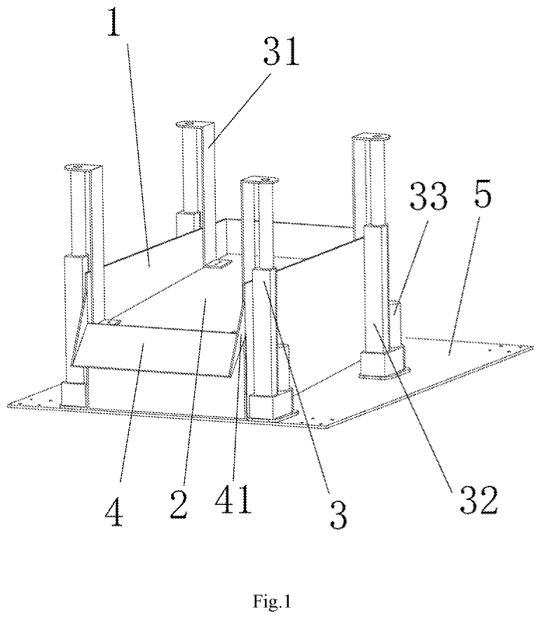

Referring to FIG. 1, an embodiment of the present disclosure provides an unloading apparatus, which includes: an insert plate 1 forming a loading space, a bottom plate 2 lifting up and down relative to the insert plate 1, a lifting device 3, an unloading plate 4, and a frame plate 5; the lifting device 3 is fixedly connected with the frame plate 5 and the bottom plate 2 respectively, and the unloading plate 4 is connected with a top of the insert plate 1; and a first acute angle is formed between the bottom plate 2 and the frame plate 5.

In this embodiment, the lifting device 3 is connected to the bottom plate 2, when in an extended state, the lifting device 3 can drive the bottom plate 2 to rise as a whole and realize the lifting function. A first included angle is formed between the bottom plate 2 and the frame plate 5, so that the materials in the carriage 1 is subject to a downwardly inclined sliding force, and the inclination direction of the included angle is consistent with the inclination direction of the unloading plate 4, inclination direction of the angle is consistent with the inclination direction of the unloading plate 4. When the bottom plate 2 is lifted to the height of the unloading plate 4, the materials slide down to the unloading plate 4 due to gravity, and thus automatic unloading is achieved. The operation process is simple, the sliding speed is stable, which effectively protects the materials and reduce the damage to the materials.

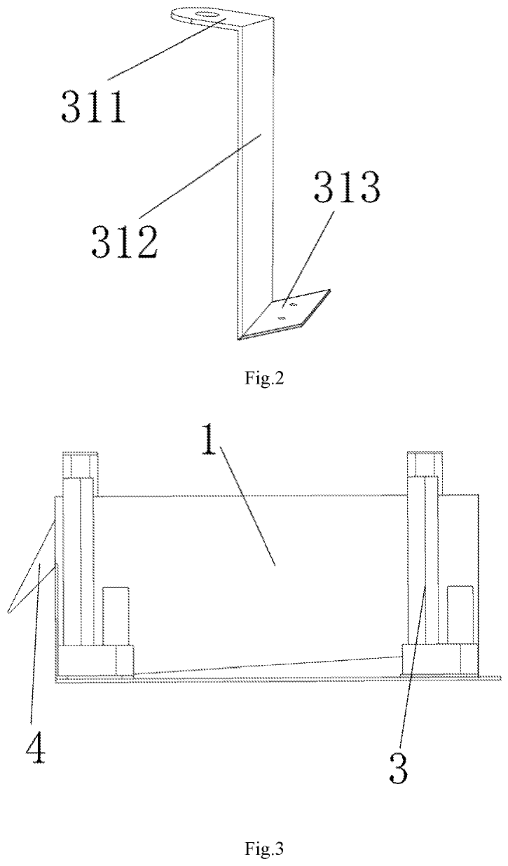

Further, referring to FIG. 2, another embodiment of the present disclosure further provides an unloading apparatus, wherein the lifting device 3 includes: a Z-shaped connector 31, a push rod 32 and a stepping motor 33; the push rod 32 is fixedly arranged outside the loading space; the Z-shaped connector 31 includes: a first connecting piece 311, a second connecting piece 312 and a third connecting piece 313, the first connecting piece 311 is connected to the push rod 32, the third connecting piece 313 is connected to the bottom plate 2, the second connecting piece 312 is located in the loading space and is fixedly connected to the first connecting piece 311 and the third connecting piece 313; the plane where the first connecting piece 311 is located and the plane where the third connecting piece 313 is located form a second acute angle that is consistent with the first acute angle; the stepping motor 33 is connected to the push rod 32.

In this embodiment, the stepping motor 33 can drive the push rod 32 to extend and contract, the first connecting piece 311 of the Z-shaped connector 31 is connected to the push rod 32, and the third connecting piece 313 is connected to the bottom plate 2, when the push rod 32 is extended, the Z-shaped connecting member 31 is driven to rise, thereby realizing the operation of lifting the bottom plate 2. According to angular position of geometric object, the second acute angle formed by the plane where the first connecting piece 311 is located and the plane where the third connecting piece 313 is located is consistent with the angle of the first acute angle.

Further, another embodiment of the present disclosure further provides an unloading apparatus, wherein the extension and contraction of the lifting device 3 is controlled by a controller.

In this embodiment, the lifting device 3 is controlled by the controller to perform a telescopic operation. When the controller issues an extension instruction, the stepping motor 33 receives the extension instruction and drives the push rod 32 to extend; when the controller issues a contraction instruction, the stepping motor 33 receives the contraction instruction and drives the push rod 32 to contract.

Further, referring to FIG. 3, another embodiment of the present disclosure further provides an unloading apparatus, wherein the first acute angle is set to 30 degrees.

In this embodiment, the first acute angle between the bottom plate 2 and the frame plate 5 is set to 30 degrees, so that the materials in the carriage 1 have a large tendency of sliding downward, which is enough to overcome the friction of the bottom plate 2 to slide downward, and setting the first acute angle to 30 degrees can ensure that there are enough volume in the carriage for placing materials.

Further, another embodiment of the present disclosure further provides an unloading apparatus, wherein the insert plate 1 is provided with a depression, and the unloading plate 4 is connected with the insert plate 1 at the depression.

In this embodiment, arrangement of the depression enables the materials automatically slide down to the unloading plate 4 when the materials on the bottom plate 2 rises to the height of the depression, the structure thereof is simple, and all the materials can be controlled to slide down onto the unloading plate 4.

Further, another embodiment of the present disclosure further provides an unloading apparatus, wherein, two sides of the unloading plate 4 are provided with fixing plates 41 for strengthening the connection with the insert plate 1 and guiding the unloading of materials; the fixing plate 41 is fixedly connected with the insert plate 1 at the depression.

In this embodiment, the fixing plate 41 can enhance the stability of the unloading plate 4 so that it is not easy to break, and the direction in which the materials on the unloading plate 4 slide down can be controlled, so that the materials slide to a fixed position.

In addition, referring to FIGS. 1-3, another embodiment of the present disclosure further provides an unloading apparatus, including: an insert plate 1 forming a loading space 1, a bottom plate 2 that lifts up and down relative to the insert plate 1, a lifting device 3, an unloading plate 4 and a frame plate 5; the lifting device 3 is fixedly connected to the frame plate 5 and the bottom plate 2, respectively, and the unloading plate 4 is connected to a top of the insert plate 1; a first acute angle is formed between the bottom plate 2 and the frame plate 5; the lifting device 3 includes: a Z-shaped connecting member 31, a push rod 32 and a stepping motor 33; the push rod 32 is fixedly arranged outside the loading space; the Z-shaped connecting piece 31 includes: a first connecting piece 311, a second connecting piece 312 and a third connecting piece 313, the first connecting piece 311 is connected to the push rod 32, the third connecting piece 313 is connected to the bottom plate 2, and the second connecting piece 312 is located in the loading space and is fixedly connected to the first connecting piece 311 and the third connecting piece 313; the plane where the first connecting piece 311 is located and the plane where the third connecting piece 313 is located form a second acute angle that is consistent with the first acute angle; the stepping motor 33 is connected to the push rod 32; the extension and contraction of the lifting device 3 is controlled by a controller; the first acute angle is set to 30 degrees; the insert plate 1 is provided with a depression, and the unloading plate 4 is connected with the insert plate 1 at the depression; fixing plates 41 are provided on two sides of the unloading plate 4 to strengthen the connection with the insert plate 1 and guide the unloading of materials; the fixing plate 41 is fixedly connected to the insert plate 1 at the depression.

In this embodiment, the stepping motor 33 can receive instructions from the controller, thereby driving the push rod 32 to extend and contract; the first connecting piece 311 of the Z-shaped connecting piece 31 is connected to the push rod 32, and the third connecting piece 313 is connected to the bottom plate 2. When the push rod 32 is extended, the Z-shaped connecting piece 31 is driven to rise, thereby realizing the operation of lifting the bottom plate 2.

The first acute angle between the bottom plate 2 and the frame plate 5 is set to 30 degrees, so that the materials in the carriage 1 have a large tendency of sliding downward, which is enough to overcome the friction of the bottom plate 2 to slide downward, and setting the first acute angle to 30 degrees can ensure that the volume in the compartment is enough for placing materials. According to angular position of geometric object, the second acute angle formed by the plane where the first connecting piece 311 is located and the plane where the third connecting piece 313 is located is consistent with the first acute angle, that is, the second acute angle is set to 30 degrees.

Arrangement of the depression enables the materials automatically slide down to the unloading plate 4 when the materials on the bottom plate 2 rises to the height of the depression, the structure thereof is simple, and all the materials can be controlled to slide down onto the unloading plate 4. The fixing plate 41 can enhance the stability of the unloading plate 4 so that it is not easy to break, and the direction in which the materials on the unloading plate 4 slide down can be controlled, so that the materials slide to a fixed position.

When the materials in the carriage 1 needed to be unloaded by the unloading apparatus, the user sends an extension instruction to the stepping motor 33 through the controller, after receiving the extension instruction, the stepping motor 33 drives the push rod 32 to extend, and the Z-shaped connecting member 31 drives the bottom plate 2 to lift. The inclination direction of the included angle is set to be consistent with the inclination direction of the unloading plate 4 so that, when the bottom plate 2 is lifted to the height of the unloading plate 4, due to gravity, the materials slides down from the bottom plate 2 to the unloading plate 4, and then from the unloading plate 4 to a fixed location, thus realize automatic unloading. The operation process of the apparatus is simple, the sliding speed of the material is stable, which effectively protects the material and reduces damage.

The above is a specific description of the preferred embodiment of the disclosure, but the disclosure is not limited to the above embodiment, those skilled in the art can make various equivalent modifications or substitutions without violating the concept of the present disclosure. These equivalent modifications or substitutions are included in the scope defined by the claims of the present application.

1. An unloading apparatus, comprising: an insert plate forming a loading space, a bottom plate configured for lifting up and down relative to the insert plate, a lifting device, an unloading plate, and a frame plate; wherein the lifting device is fixedly connected with the frame plate and the bottom plate respectively, and the unloading plate is connected with a top of the insert plate; and a first acute angle is formed between the bottom plate and the frame plate.

2. The unloading apparatus of claim 1, wherein,
the lifting device comprises: a z-shaped connector, a push rod and a stepping motor; the push rod is fixedly arranged outside the loading space;
the Z-shaped connector comprises: a first connecting piece, a second connecting piece and a third connecting piece, the first connecting piece is connected to a push rod, and the third connecting piece is connected to the bottom plate, the second connecting piece is arranged in the loading space and fixedly connected to the first connecting piece and the third connecting piece; a plane where the first connecting piece is located and a plane where the third connecting piece is located form a second acute angle that is consistent with the first acute angle;
the stepping motor is connected with the push rod.

3. The unloading apparatus of claim 1, wherein extension and contraction of the lifting device is controlled by a controller.

4. The unloading apparatus of claim 1, wherein the first acute angle is set to 30 degrees.

5. The unloading apparatus of claim 1, wherein the insert plate is provided with a depression, and the unloading plate is connected with the insert plate at the depression.

6. The unloading apparatus of claim 5, wherein two sides of the unloading plate are provided with a fixing plate for enhancing strength of the unloading plate and guiding unloading of materials; the fixing plate is fixedly connected with the insert plate at the depression.
